(19) United States
(12) Patent Application Publication
(10) Pub. No.: US 2012/0290939 A1
(43) Pub. Date: Nov. 15, 2012

(54) APPARATUS, METHOD, COMPUTER PROGRAM AND USER INTERFACE

(75) Inventors: Kun Yu, Beijing (CN); Hao Wang, Beijing (CN)

(73) Assignee: NOKIA CORPORATION, Espoo (FI)

(21) Appl. No.: 13/519,761

(22) PCT Filed: Dec. 29, 2009
(86) PCT No.: PCT/CN09/76190

§ 371 Date: Jun. 28, 2012

(51) Int. Cl. G06F 3/048; G06F 17/30

(52) U.S. Cl. 715/741

(57) ABSTRACT

An apparatus, method, computer program and user interface wherein the apparatus comprises: at least one processor: and at least one memory including computer program code; wherein the at least one memory and the computer program code are configured to, with the at least one processor, enable the apparatus to: configure the apparatus in a first mode of operation in which access to at least one function of the apparatus is disabled; display a plurality of items where a subset of the displayed items are associated with information which satisfies a predetermined criteria, wherein the information comprises contextual information; detect user selection of one or more of the items; determine whether or not the selected items satisfy the predetermined criteria; if the predetermined criteria is satisfied, configure the apparatus in a second mode of operation in which access to the at least one function of the apparatus is enabled; and if the predetermined criteria is not satisfied the apparatus is not configured in the second mode of operation.

### FIELD OF THE INVENTION

Embodiments of the present invention relate to an apparatus, method, computer program and user interface. In particular, they relate to an apparatus, method, computer program and user interface for enabling access to functions of an apparatus.

### BACKGROUND TO THE INVENTION

An apparatus may have a plurality of modes of operation. For example, an apparatus may have an active mode of operation in which access to the functions of the apparatus is not restricted so that the user can freely access all of the functions of the apparatus. The apparatus may also have a restricted mode of operation in which access to one or more of the functions is disabled. Once the apparatus has been configured in the restricted mode of operation it may be useful to ensure that the active mode of operation can only be accessed by authorized users or cannot be accessed inadvertently.

### BRIEF DESCRIPTION OF VARIOUS EMBODIMENTS OF THE INVENTION

According to various, but not necessarily all, embodiments of the invention there is provided an apparatus comprising: at least one processor: and at least one memory including computer program code; wherein the at least one memory and the computer program code are configured to, with the at least one processor, enable the apparatus to: configure the apparatus in a first mode of operation in which access to at least one function of the apparatus is disabled; display a plurality of items where a subset of the displayed items are associated with information which satisfies a predetermined criteria, wherein the information comprises contextual information; detect user selection of one or more of the items; determine whether or not the selected items satisfy the predetermined criteria; if the predetermined criteria is satisfied, configure the apparatus in a second mode of operation in which access to the at least one function of the apparatus is enabled; and if the predetermined criteria is not satisfied the apparatus is not configured in the second mode of operation.

In some embodiments of the invention the contextual information may comprise user dependent information.

In some embodiments of the invention the contextual information may comprise information relating to the history of use of the apparatus. The contextual information may comprise information obtained from one or more databases where the one or more databases are associated with functions of the apparatus.

In some embodiments of the invention the at least one function may enable a user to make inputs and also enable an output to be provided to a user. The at least one function may comprise a communications function. The at least one function may enable content to be rendered.

In some embodiments of the invention the predetermined criteria may comprise an authentication question and the subset of items which satisfy the predetermined criteria may provide correct answers to the authentication question. Each of the displayed items may comprise a feasible answer to the authentication question. The authentication question may be determined by a user before the apparatus is configured in the restricted mode of operation. The authentication question may be displayed on the display in the restricted mode of operation.

In some embodiments of the invention the predetermined criteria may comprise a permutation of the subset of items.

In some embodiments of the invention the plurality of displayed items may comprise images. The images may be displayed in a networked graph.

In some embodiments of the invention the items displayed on the display may be updated every time the apparatus enters the restricted mode.

In some embodiments of the invention the predetermined criteria may be updated every time the apparatus enters the restricted mode.

According to various, but not necessarily all, embodiments of the invention there is also provided a method comprising: configuring an apparatus in a first mode of operation in which access to at least one function of the apparatus is disabled; displaying a plurality of items where a subset of the displayed items are associated with information which satisfies a predetermined criteria, wherein the information comprises contextual information; detecting user selection of one or more of the items; determining whether or not the selected items satisfy the predetermined criteria; if the predetermined criteria is satisfied, configuring the apparatus in a second mode of operation in which access to the at least one function of the apparatus is enabled; wherein, if the predetermined criteria is not satisfied the apparatus is not configured in the second mode of operation.

According to various, but not necessarily all, embodiments of the invention there is provided a computer program comprising computer program instruction means configured to control an apparatus, the program instructions enabling, when loaded into the at least one processor; configuring the apparatus in a first mode of operation in which access to at least one function of the apparatus is disabled; displaying a plurality of items where a subset of the displayed items are associated with information which satisfies a predetermined criteria, wherein the information comprises contextual information; detecting user selection of one or more of the items; determining whether or not the selected items satisfy the predetermined criteria; if the predetermined criteria is satisfied, configuring the apparatus in a second mode of operation in which access to the at least one function of the apparatus is enabled; wherein, if the predetermined criteria is not satisfied the apparatus is not configured in the second mode of operation.

In some embodiments of the invention there may also be provided a computer program comprising program instructions for causing a computer to perform the method as described above.

In some embodiments of the invention there may also be provided a physical entity embodying the computer program as described above.

In some embodiments of the invention there may also be provided an electromagnetic carrier signal carrying the computer program as described above.

According to various, but not necessarily all, embodiments of the invention there is provided a user interface comprising: a display configured to display a plurality of items when an apparatus is in a first mode of operation in which access to at least one function of the apparatus us disabled, where a subset of the displayed items are associated with information which satisfies a predetermined criteria, wherein the information comprises contextual information; a user input device configured to enable user selection of one or more of the items and enable determination of whether or not the selected items satisfy the predetermined criteria; wherein if the predetermined criteria is satisfied, the apparatus is configured in a second mode of operation in which access to the at least one function of the apparatus is enabled; and if the predetermined criteria is not satisfied the apparatus is not configured in the second mode of operation.

According to various, but not necessarily all, embodiments of the invention there is provided an apparatus comprising: means for configuring the apparatus in a first mode of operation in which access to at least one function of the apparatus is disabled; means for displaying a plurality of items where a subset of the displayed items are associated with information which satisfies a predetermined criteria, wherein the information comprises contextual information; means for detecting user selection of one or more of the items; means for determining whether or not the selected items satisfy the predetermined criteria; means for configuring, if the predetermined criteria is satisfied, the apparatus in a second mode of operation in which access to the at least one function of the apparatus is enabled; wherein, if the predetermined criteria is not satisfied the apparatus is not configured in the second mode of operation.

The apparatus may be for wireless communications.

### BRIEF DESCRIPTION OF THE DRAWINGS

For a better understanding of various examples of embodiments of the present invention reference will now be made by way of example only to the accompanying drawings in which:

FIG. 1 schematically illustrates an apparatus according to an exemplary embodiment of the invention;

FIG. 2 schematically illustrates an apparatus according to another exemplary embodiment of the invention;

FIG. 3 is a block diagram which schematically illustrates a method according to an exemplary embodiment of the invention;

FIGS. 4A to 4D illustrate a first exemplary embodiment of the invention in use;

FIGS. 5A to 5B illustrate a second exemplary embodiment of the invention in use; and

FIGS. 6A to 6B illustrate a third exemplary embodiment of the invention in use.

### DETAILED DESCRIPTION OF VARIOUS EMBODIMENTS OF THE INVENTION

The Figures illustrate an apparatus 1 comprising: at least one processor 3: and at least one memory 5 including computer program code 9; wherein the at least one memory 5 and the computer program code 9 are configured to, with the at least one processor 3, enable the apparatus 1 to: configure 31 the apparatus 1 in a first mode of operation in which access to at least one function of the apparatus 1 is disabled; display 33 a plurality of items 41A to 41I where a subset of the displayed items 41A to 41I are associated with information which satisfies a predetermined criteria, wherein the information comprises contextual information relating to the at least one function; detect 35 user selection of one or more of the items; determine 37 whether or not the selected items satisfy the predetermined criteria; if the predetermined criteria is satisfied, configure 39 the apparatus 1 in a second mode of operation in which access to the at least one function of the apparatus is enabled; and if the predetermined criteria is not satisfied the apparatus 1 is not configured 41 in the second mode of operation.

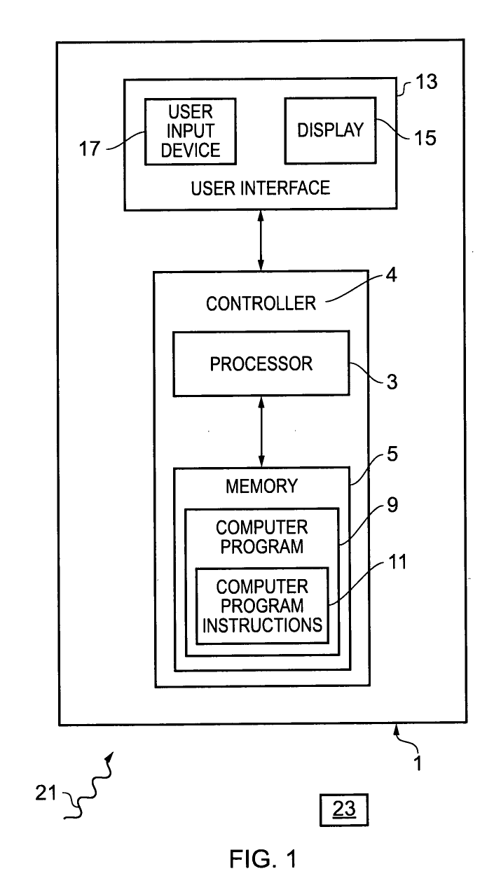

FIG. 1 schematically illustrates an apparatus 1 according to an embodiment of the invention. The apparatus 1 may be an electronic apparatus. The apparatus 1 may be, for example, a mobile cellular telephone, a personal computer, a camera, a personal digital assistant, a personal music player or any other apparatus which has one or more functions. The apparatus 1 may be a handheld apparatus 1 which can be carried in a user's hand, handbag or jacket pocket for example.

The apparatus 1 is configured to provide one or more functions to a user. The functions may enable a user to make user inputs to control the apparatus 1 and to input information into the apparatus 1. The one or more functions may also enable an output to be provided to the user. In some embodiments of the invention the functions may comprise communications functions. For example the functions may enable the apparatus 1 to connect to a communications network and transmit and receive information via the communications network. In some embodiments of the invention the functions may enable content to be rendered. For example they may enable a user to select content and enable the selected content to be provided as an output. The content may comprise audio content, such as a musical track or a spoken message. The content may also comprise visual content for example, an image such as a photograph or text. The content may also comprise audio-visual content which comprises both audio content and visual content, for example a video clip.

Only features referred to in the following description are illustrated in FIG. 1. However, it should be understood that the apparatus 1 may comprise additional features that are not illustrated. For example, in embodiments of the invention where the apparatus 1 is a mobile cellular telephone, the apparatus 1 may also comprise a transmitter and receiver configured to enable wireless communication.

The illustrated apparatus 1 comprises: a user interface 13 and a controller 4. In the illustrated embodiment the controller 4 comprises at least one processor 3 and at least one memory 5 and the user interface 13 comprises a display 15 and a user input device 17.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The controller 4 may be configured to control the apparatus 1 to perform a plurality of different functions. For example, where the apparatus 1 is a mobile cellular telephone the controller 4 may be configured to control the apparatus 1 to make and receive telephone calls and also to perform other functions such as send messages or access communication networks such as local area networks or the internet.

The controller 4 may also be configured to enable the apparatus 1 to configure the apparatus 1 in a first mode of operation in which access to at least one function of the apparatus 1 is disabled; display 33 a plurality of items 41A to 41I where a subset of the displayed items 41A to 41I are associated with information which satisfies a predetermined criteria, wherein the information comprises contextual information relating to the at least one function; detect 35 user selection of one or more of the items 41A to 41I; determine 37 whether or not the selected items satisfy the predetermined criteria; if the predetermined criteria is satisfied, configure 39 the apparatus 1 in a second mode of operation in which access to the at least one function of the apparatus is enabled; and if the predetermined criteria is not satisfied the apparatus 1 is not configured 41 in the second mode of operation.

The at least one processor 3 is configured to receive input commands from the user interface 13 and also to provide output commands to the user interface 13. The at least one processor 3 is also configured to write to and read from the at least one memory 5. The output of the user interface 13 is provided as an input to the controller 4.

The user interface 13 provides means for enabling a user of the apparatus 1 to input information which may be used to control the apparatus 1. The user interface 13 may also enable a user to input information which may be stored in the one or more memories 5 of the apparatus 1.

The user input device 17 may comprise any means which enables a user to input information into the apparatus 1. For example the user input device 17 may comprise a keypad or a portion of a touch sensitive display 15 or a combination of a number of different types of user input devices.

The display 15 may comprise any means which enables information to be displayed to a user of the apparatus 1. The information may correspond to information which has been input by the user via the user input device 17, information which is stored in the one or more memories 5 or information which has been received by apparatus 1. The display 15 may also be configured to render content such as images.

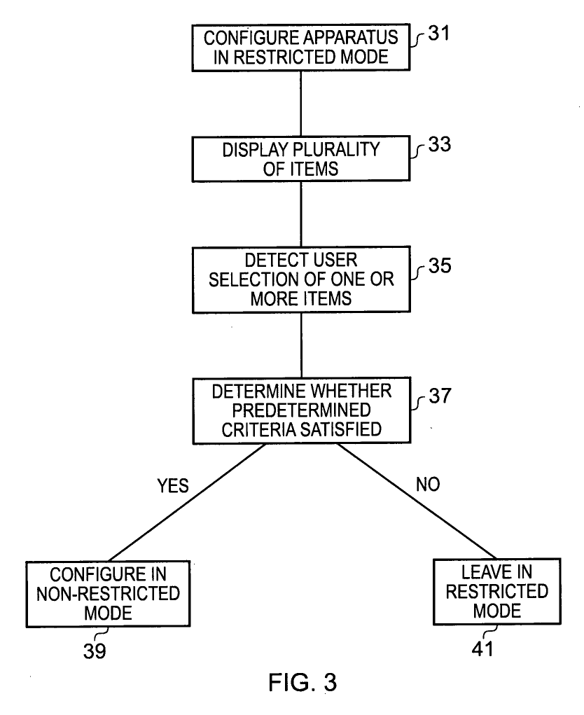

The at least one memory 5 stores a computer program code 9 comprising computer program instructions 11 that control the operation of the apparatus 1 when loaded into the at least one processor 3. The computer program instructions 11 provide the logic and routines that enables the apparatus 1 to perform the methods illustrated in FIG. 3. The at least one processor 3 by reading the at least one memory 5 is able to load and execute the computer program 9.

The computer program instructions 11 may provide computer readable program means configured to control the apparatus 1. The program instructions 11 may provide, when loaded into the controller 4; means for configuring 31 the apparatus 1 in a first mode of operation in which access to at least one function of the apparatus 1 is disabled; means for 15 displaying 33 a plurality of items 41A to 41I where a subset of the displayed items 41A to 41I are associated with information which satisfies a predetermined criteria, wherein the information comprises contextual information relating to the at least one function; means for detecting 35 user selection of one or more of the items 41A to 41I; determining 37 whether or not the selected items satisfy the predetermined criteria; means for, configuring 39 the apparatus 1, if the predetermined criteria is satisfied, in a second mode of operation in which access to the at least one function of the apparatus 1 is enabled; wherein, if the predetermined criteria is not satisfied the apparatus 1 is not configured 41 in the second mode of operation.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program code 9. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application integration specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The one or more memory 5 may also be configured to store one or more databases. The databases may comprise information which may be used by the apparatus 1 when performing particular functions. Different databases may be associated with different functions of the apparatus 1.

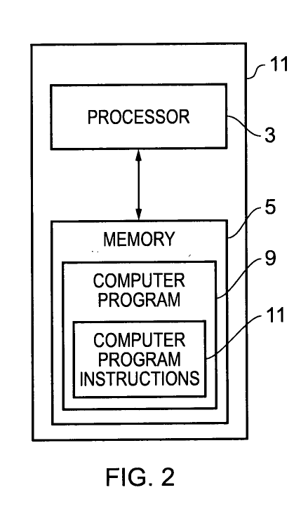

FIG. 2 illustrates an apparatus 1′ according to another embodiment of the invention. The apparatus 1′ illustrated in FIG. 2 may be a chip or a chip-set. The apparatus 1′ comprises at least one processor 3 and at least one memory 5 as described above in relation to FIG. 1.

A method of controlling the apparatus 1, according to embodiments of the invention, is illustrated schematically in FIG. 2.

At block 31 the apparatus 1 is configured in a restricted mode of operation. In the restricted mode of operation access to at least one function of the apparatus 1 is disabled.

In some embodiments of the invention the apparatus 1 may be configured in a restricted mode of operation to prevent inadvertent access to the functions of the apparatus 1. For example the apparatus 1 may be configured in a mode of operation in which the user input device 17 is non-responsive to user actuation. This enables the user input device 17 to be locked when the apparatus 1 is not in use so that it may be carried in a pocket or a handbag without inadvertently initiating functions of the apparatus 1. In such embodiments of the invention, even when the apparatus 1 is in the restricted mode of operation, the apparatus 1 may still be configured to perform functions which are not initiated by a user input. For example, the apparatus 1 may still be configured to receive an incoming message or telephone call and provide an alert to the user.

In other embodiments of the invention the apparatus 1 may be configured in a restricted mode of operation to prevent unauthorized access to one or more functions of the apparatus 1. For example the apparatus may comprise functions which the user of the apparatus 1 would like to keep secure and prevent other people from accessing. For example the user may wish to prevent other people from accessing the communications functions of the apparatus 1. In some embodiments of the invention the user may wish to prevent other people from accessing information which may be stored in one or more of the memories 5 of the apparatus 1. For example the information may be personal information such as contact details, calendar information, photographs or personal messages which have been received via a communications function.

The apparatus 1 may be configured in the restricted mode of operation in response to a user input. For example the user may make an input which locks the user input device 17 or prevents unauthorized users from accessing the at least one function of the apparatus 1. In other embodiments of the invention the apparatus 1 may be configured in the restricted mode automatically without any specific user input. For example, the apparatus 1 may be configured in the restricted mode if no user input is detected for a predetermined period of time or once a function has been completed.

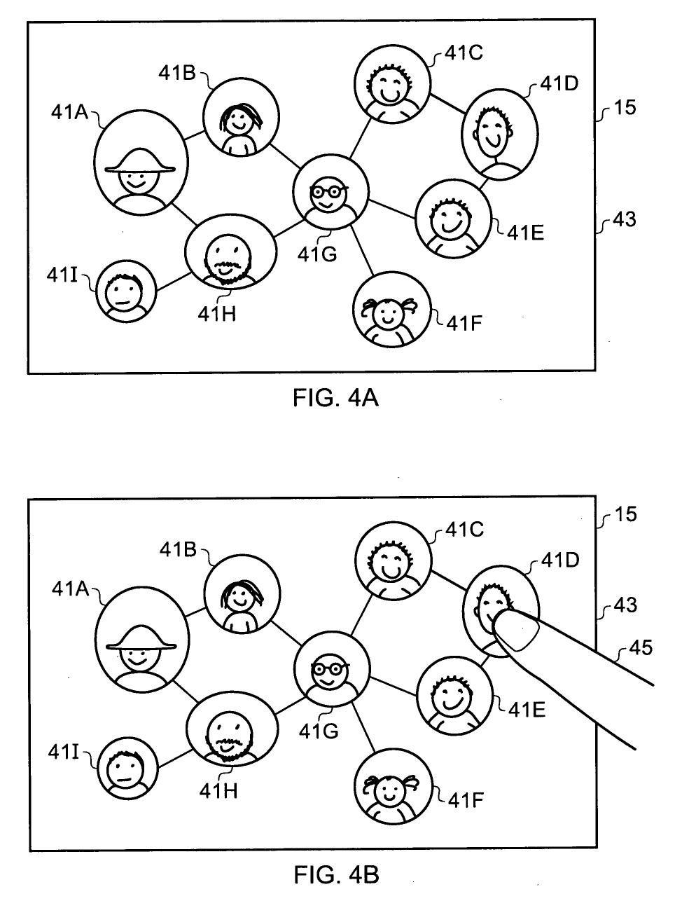

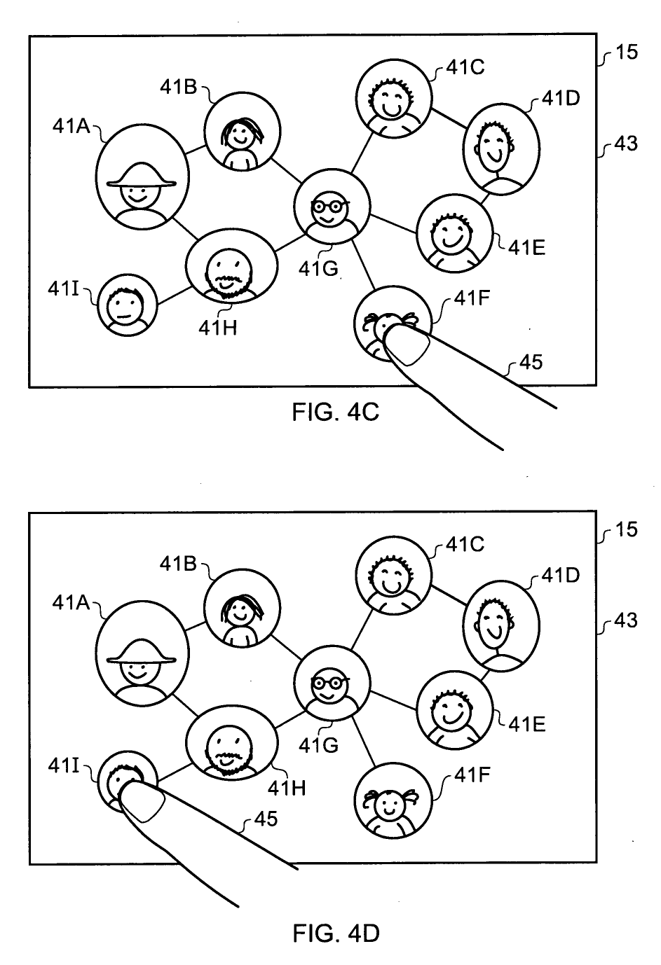

At block 33 a plurality of items 41A to 41I are displayed on the display 15. FIGS. 4A, 5A and 6A illustrate an example of a plurality of items 41A to 41I being displayed on the display 15.

In some embodiments of the invention the items 41A to 41I may comprise images. The images may be stored in a database in the one or more memories 5 of the apparatus 1. In other embodiments of the invention the plurality of items 41A to 41I may comprise a piece of text such as the name of a person. In some embodiments of the invention the text may be presented with the image and may provide an indication of information associated with the image. In other embodiments of the invention the items 41A to 41I may comprise video images. It is to be appreciated that different types of items 41A to 41I may also be displayed simultaneously.

The items 41A to 41I are associated with contextual information which relates to functions of the apparatus 1. The contextual information may relate to the at least one function to which access has been disabled. The contextual information may be user dependent. It may be unique to user and to the apparatus 1. The contextual information may be known to the user of the apparatus 1 and may be obtained by the processor 3 from information stored in one or more databases associated with functions of the apparatus 1 which are accessible by the processor 3. The one or more databases may be stored in the one or more memories 5.

The contextual information may comprise information which may vary in time. For example it may comprise information relating to the use history of the apparatus 1. In such embodiments the contextual information may be updated whenever a relevant new event occurs which changes the use history of the apparatus 1. For example, the contextual information may comprise information relating to communications functions such as the call history of a telephone. In such embodiments a relevant event may be the receiving or making of a telephone call and the contextual information may be updated every time a call is made or received.

The contextual information may also comprise information which has been input by the user of the apparatus 1 or which has been received by the apparatus 1. For example it may comprise information which is stored in a contacts record or in a calendar.

Subsets of the displayed items are associated with contextual information which satisfies predetermined criteria. The predetermined criteria may comprise an authentication question and the subset may comprise correct answers to the authentication question. For example, each of the items may represent a person whose contact details are stored in a contacts record of the apparatus 1. The authentication question may be “which three people live closest to the user of the apparatus?” and the subset of items which satisfy the predetermined criteria would be the three items representing the people who live closest to the user according to the information in the contacts record.

Each of the displayed items 41I to 41G which are not part of the subset may provide a feasible answer to the authentication question. For example, where the answer to the authentication question would be a person, each displayed item may represent a person rather than an event in a calendar or a piece of content.

The authentication question may be any question relating to the functions of the apparatus 1 to which the answer may feasibly be known to the user and which may be obtained by the apparatus 1 by accessing databases of information associated with functions of the apparatus 1. The authentication question may relate to the at least one function to which access has been disabled. This prevents an unauthorized user from being able to obtain the answer by using the other functions of the apparatus 1.

The authentication question may be determined by the user of the apparatus 1 before the apparatus 1 is configured in the restricted mode of operation. The user may select the authentication question from a plurality of potential questions. This may enable the user to select an authentication question which they may easily remember the answer to.

It is to be appreciated that the authentication question may be any question relating to functions of the apparatus 1. The authentication question may have a positive answer, for example the question may ask which contacts have been contacted most recently. Alternatively the authentication question may have a negative answer. For example, which contacts have not been contacted recently. The user may be able to select between positive authentication questions and negative authentication questions.

In some embodiments of the invention the authentication question may also be displayed on the display 15. In such embodiments of the invention the user does not have to remember what the authentication question was or, in fact, have ever known what the authentication question was. This may also enable a different authentication question to be used every time the apparatus 1 is configured in the restricted mode of operation. This may provide an additional level of security to the apparatus 1 as the correct answers to the authentication question may be different every time.

Alternatively, in other embodiments of the invention the authentication question might not be displayed on the display 15. This may also be very secure as an unauthorized person would need to know, not only the answer to the authentication question, but also the authentication question itself.

The predetermined criteria may also comprise a specific permutation in which the subset of items must be selected. In such embodiments the question may imply an order and the items may have to be selected in the correct order. As an example, the question may be “which three contacts were called most recently?” and the predetermined criteria may require that the most recent contact is selected first followed by the second most recent and then the third most recent.

At block 35 the controller 4 detects a user input made via the user input device 17 corresponding to selection of one or more the displayed items 41A to 41I.

At block 37 the controller 4 determines whether or not the items selected at block 35 satisfy the predetermined criteria. Block 37 may only occur once a predetermined number of items 41A to 41I have been selected. For example, if the subset of items which satisfies the predetermined criteria comprises three items then block 37 may only occur once three items have been selected. In other embodiments of the invention block 37 may occur whenever an item is selected.

The controller 4 may determine whether or not the selected items satisfy the predetermined criteria by comparing information associated with the selected items with information stored in a database. If there is a correlation between the information then the predetermined criteria is considered to be satisfied.

If the predetermined criteria is satisfied then, at block 39, the apparatus 1 is configured in a non-restricted mode of operation in which access to the at least one function is enabled. Conversely, if the predetermined criteria is not satisfied then, at block 41, the apparatus 1 is not configured in the non-restricted mode of operation.

In some embodiments of the invention, if the predetermined criteria is not satisfied then, at block 41, the method may return to block 33 to provide the user with a further opportunity to select items from the plurality of displayed items 41A to 41I. When the method returns to block 33 the authentication question may be changed or the items 41A to 41I presented on the display 15 may be changed. In other embodiments of the invention a different method of authorization may be requested, for example, a password or pin code may be requested. Alternatively the apparatus 1 may become permanently locked to prevent unauthorized access to the functions of the apparatus 1.

The blocks illustrated in the FIG. 3 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

FIGS. 4A to 4D illustrate a first embodiment of the invention in use. FIG. 4A illustrates a graphical user interface 43 according to embodiments of the invention. The graphical user interface 43 may be presented on the display 15 of the apparatus 1. In the embodiment illustrated in FIGS. 4A to 4D the display is a touch sensitive user input display 15 so that the surface of the display 15 is operable as the user input device 17 to detect the user inputs. A user may actuate the touch sensitive display 15 by using their finger 45, 51, 53 or thumb or any other suitable object such as a stylus to physically make contact with the surface of the display 15. In some embodiments of the invention the user may also be able to actuate the touch sensitive display 15 by bringing their finger 45, 51, 53, thumb or stylus close to the surface of the touch sensitive display 15. The touch sensitive display 15 may be a capacitive touch sensitive display, resistive touch sensitive display or any other type of touch sensitive display.

In FIG. 4A the apparatus 1 is configured in the restricted mode of operation so that access to at least one function has been disabled. A plurality of items 41A to 41I are displayed 31 on the display 15. In the illustrated embodiment each item 41A to 41I comprises an image. In the particular embodiment illustrated in FIG. 4A each image is of a person and represents a person whose contact details are stored in a contact record in a memory 5 of the apparatus 1. The contact record may be associated with one or more functions of the apparatus 1. For example it may comprise information such as telephone numbers or email addresses which may be used to enable communications functions. The contact record may also comprise information relating to the history of contact between the user of the apparatus and the person in the contact record. For example it may include information relating to the times, date and duration of the most recent telephone calls or messages.

In FIG. 4A the items 41A to 41I are displayed as a networked graph. This provides an interface which is intuitive to the user and may also enable displayed items 41A to 41I to be interconnected with each other. The networked graph may be representative of a user's social network. For example where the displayed items 41A to 41I represent people whose contact details are stored in a memory 5 of the apparatus 1 the networked graph may link people who are connected with each other. That is, it may link contacts who have been indicated as being in the same social group for example contacts who have been indicated as friends may be linked to other contacts that have been indicated as friends while contacts who have been indicated as colleagues may be linked to other contacts that have been indicated as colleagues. In other embodiments of the invention the apparatus may be able to access social networks to determine which contacts are also known to other contacts. The lines on the networked graph may indicate the social connections which are identified. The networked graph may change over time as the user makes new contacts and changes their social connection between existing contacts.

The social network may comprise an internet social network. For example it may relate to any internet based application which enables users to communicate and or/share content. Each node on the networked graph may correspond to a contact from the social network with which the user can send or receive messages or share content. The social network may enable the user to define other contacts as part of specific groups such as colleagues, friends or family. The social network may enable the user to request that other people join their social network or accept requests from other users to join the social network of another user.

In FIG. 48 the user selects a first item 41D by actuating the surface of the display 15 in the area in which the first item 41D is displayed with their finger 45. Once the first item 41D has been selected the first item 41D may be displayed in a manner to distinguish it from the other displayed items 41A to 41C and 41E to 41I which have not been selected. For example it may be highlighted or the perimeter around the item 41D may be displayed in a different color.

In FIG. 4C the user selects a second item 41F by actuating the surface of the display 15 in the area in which the second item 41F is displayed with their finger 45. Similarly, in FIG. 4D the user selects a third item 41I by using their finger 45 to actuate the surface of the display 15 in the area in which the second item 41I is displayed.

Once the third item has been selected the controller 4 determines whether or not the selected items 41D, 41F, and 41I satisfy the predetermined criteria. If the predetermined criteria has been satisfied then the apparatus is configured 39 in a second mode of operation and access to the at least one function is enabled. If the predetermined criteria has not been satisfied then the apparatus is not configured 41 in the second mode of operation and access to the function is not enabled.

In some embodiments of the invention an indication may be provided to the user to indicate whether or not a correct item has been selected. For example if an incorrect item has been selected the incorrect item may be displayed in a manner which indicates this, for example, a cross may be displayed over the item. Alternatively, if a correct item has been selected a tick may be displayed over the item. In some embodiments of the invention an audio alert may be provided to provide audio feedback to the user to indicate whether or not a correct item has been selected. In other embodiments of the invention image manipulation techniques may be used, for example, if the items comprise images of people and a correct item is selected then the image could be manipulated to make the person smile.

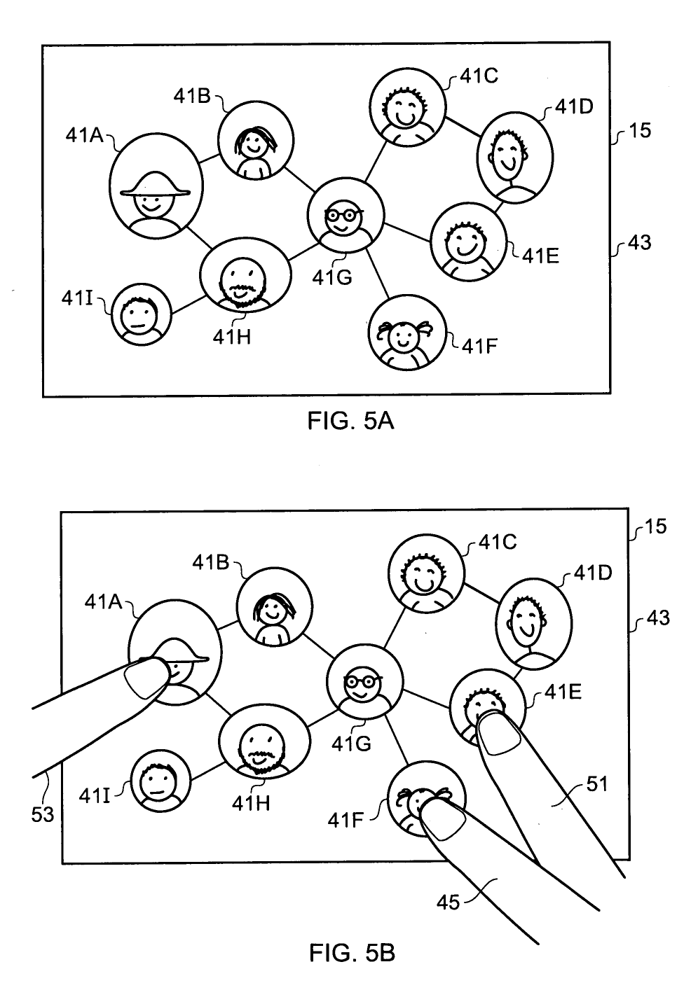

FIGS. 5A to 5B illustrate a second embodiment of the invention in use. The graphical user interface 43 illustrated in FIG. 5A corresponds to the graphical user interface illustrated in FIG. 4A. The same items 41A to 41I are displayed in the same networked graph. However it is to be appreciated that different items and/or a different network graph may be displayed every time the apparatus 1 enters the restricted mode of operation.

In FIG. 5B the user selects three items simultaneously by making a multi-touch input using three different fingers 45, 51 and 53. The user simultaneously actuates the surface of the display 15 in three area in which three different items 41A, 41E and 41F are displayed.

As in the embodiment described above, once the three items have been selected the controller 4 determines whether or not the selected items 41A, 41E and 41F satisfy the predetermined criteria. If the predetermined criteria has been satisfied then the apparatus is configured in a second mode of operation and access to the function is enabled and if the predetermined criteria has not been satisfied then the apparatus is not configured in the second mode of operation and access to the function is not enabled.

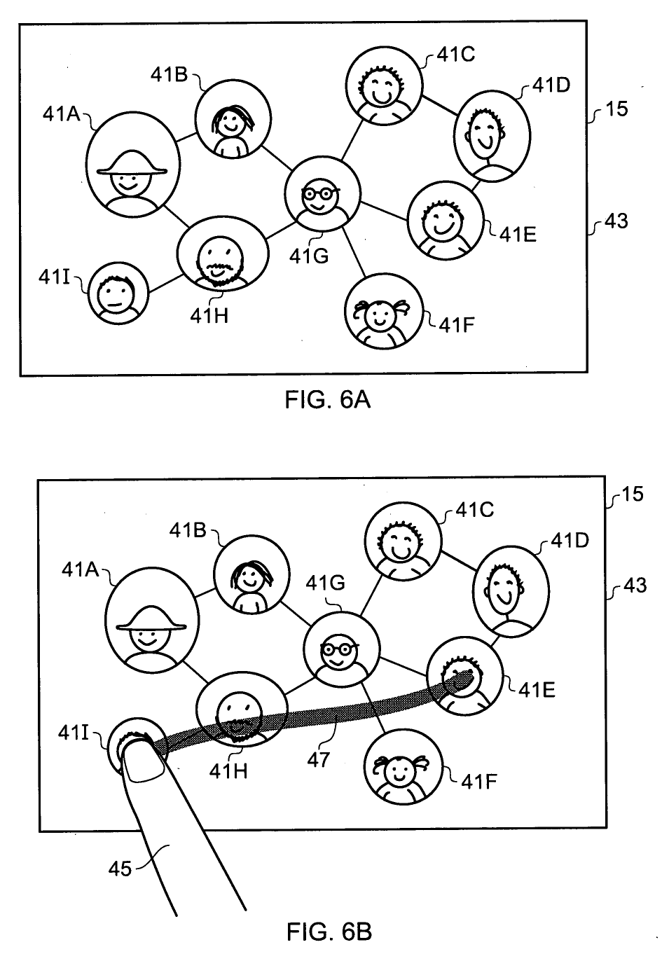

FIGS. 6A to 6B illustrate a third embodiment of the invention in use. The graphical user interface 43 illustrated in FIG. 6A corresponds to the graphical user interface 43 illustrated in FIGS. 4A and 5A. The same items 41A to 41I are displayed in the same networked graph.

In FIG. 6B the user selects three items by making a trace input. The user makes the trace input by actuating the surface of the display 15 with their finger 45 and then dragging their finger 45 across the surface of the display 15. In FIG. 6B the user has made a trace which has extended over the areas of the display 15 in which the items 41E, 41H and 41I are displayed. The trace is indicated on the display 15 by the line 47.

As in the previously described embodiments, once the three items have been selected the controller 4 determines whether or not the selected items 41E, 41H and 41I satisfy the predetermined criteria. If the predetermined criteria has been satisfied then the apparatus is configured in a second mode of operation and access to the function is enabled and if the predetermined criteria has not been satisfied then the apparatus is not configured in the second mode of operation and access to the function is not enabled.

Embodiments of the invention provide the advantages that they enable information which is specific to a user and their apparatus 1 to be used as an authentication parameter to enable access to functions of the apparatus 1. This means that the user of the apparatus 1 may no longer have to remember a pin code or password. As an alternative to remembering a code or a number the user only has to remember information which may relate to events that have occurred recently or to information which they have personally stored in the apparatus 1.

Furthermore, as the information may relate to the functions of the apparatus 1 it may comprise information which varies over time. This provides a high level of security as even if an authorized user were to notice the items selected by the user to access the function on a first occasion, the same items would not necessarily enable access on another occasion.

Also the items may be presented as images, this provides a personalized user interface which is not only secure but is enjoyable for the user to use. Also the items may be act as a trigger to remind the user of contacts that they have not contacted recently or events which are upcoming in their calendar.

Although embodiments of the present invention have been described in the preceding paragraphs with reference to various examples, it should be appreciated that modifications to the examples given can be made without departing from the scope of the invention as claimed. For example in some embodiments of the invention the items may comprise a fake item which does not relate to information personal to the user. This may increase the level of security provided by the apparatus 1 as it increases the possible number of answers to the question.

In some embodiments of the invention a user may be able to obtain access to limited information in relation to the items 41A to 41I presented on the display 15. For example, if they do not recognize an image they may be able to access limited information, for example an indication of the name of the contact represented by the image. The information may be presented in response to a specific type of input. For example, the information may be presented in response to a double tap input in the area in which the item is displayed. The information may provide a hint to enable the user to answer the authentication question

In the above described information the items 41A to 41A are primarily associated with contact information. It is to be appreciated that any type of information may be associated with the items 41A to 41A, such as calendar information or content which has been obtained or viewed by the user of the apparatus 1.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
at least one processor: and
at least one memory including computer program code;
wherein the at least one memory and the computer program code are configured to, with the at least one processor, enable the apparatus to:
configure the apparatus in a first mode of operation in which access to at least one function of the apparatus is disabled;
display a plurality of items where a subset of the displayed items are associated with information which satisfies a predetermined criteria, wherein the information comprises contextual information;
detect user selection of one or more of the items;
determine whether or not the selected items satisfy the predetermined criteria;
if the predetermined criteria is satisfied, configure the apparatus in a second mode of operation in which access to the at least one function of the apparatus is enabled; and if the predetermined criteria is not satisfied the apparatus is not configured in the second mode of operation.

2. An apparatus as claimed in claim 1 wherein the contextual information comprises at least one of user dependent information, information relating to the history of use of the apparatus and information obtained from one or more databases where the one or more databases are associated with functions of the apparatus.

3-4. (canceled)

5. An apparatus as claimed in claim 1 wherein the at least one function enables a user to make inputs and also enables an output to be provided to a user.

6. An apparatus as claimed in claim 5 wherein the at least one function comprises a communications function.

7. An apparatus as claimed in claim 5 wherein the at least one function enables content to be rendered.

8. An apparatus as claimed in claim 1 wherein the predetermined criteria comprises an authentication question and the subset of items which satisfy the predetermined criteria provide correct answers to the authentication question.

9. An apparatus as claimed in claim 8 wherein each of the displayed items comprises a feasible answer to the authentication question.

10. An apparatus as claimed in claim 8 wherein the authentication question is determined by a user before the apparatus is configured in the restricted mode of operation.

11. An apparatus as claimed in claim 8 wherein the authentication question is displayed on the display in the restricted mode of operation.

12. An apparatus as claimed in claim 1 wherein the predetermined criteria comprises a permutation of the subset of items.

13. An apparatus as claimed in claim 1 wherein the plurality of displayed items comprises images.

14. An apparatus as claimed in claim 13 wherein the images are displayed in a networked graph.

15. An apparatus as claimed in claim 1 wherein the items displayed on the display are updated every time the apparatus enters the restricted mode.

16. An apparatus as claimed in claim 1 wherein the predetermined criteria is updated every time the apparatus enters the restricted mode.

17. A method comprising:
configuring an apparatus in a first mode of operation in which access to at least one function of the apparatus is disabled;
displaying a plurality of items where a subset of the displayed items are associated with information which satisfies a predetermined criteria, wherein the information comprises contextual information;
detecting user selection of one or more of the items;
determining whether or not the selected items satisfy the predetermined criteria;
if the predetermined criteria is satisfied, configuring the apparatus in a second mode of operation in which access to the at least one function of the apparatus is enabled; wherein, if the predetermined criteria is not satisfied the apparatus is not configured in the second mode of operation.

18. A method as claimed in claim 17 wherein the contextual information comprises at least one of user dependent information, information relating to the history of use of the apparatus and information obtained from one or more databases where the one or more databases are associated with functions of the apparatus.

19-20. (canceled)

21. A method as claimed in claim 17 wherein the at least one function enables a user to make inputs and also enables an output to be provided to a user.

22. A method as claimed in claim 21 wherein the at least one function comprises a communications function.

23. A method as claimed in claim 21 wherein the at least one function enables content to be rendered.

24-32. (canceled)

33. A physical entity embodying a computer program comprising computer program instruction means configured to control an apparatus, the program instructions enabling, when loaded into the at least one processor;
configuring the apparatus in a first mode of operation in which access to at least one function of the apparatus is disabled;
displaying a plurality of items where a subset of the displayed items are associated with information which satisfies a predetermined criteria, wherein the information comprises contextual information;
detecting user selection of one or more of the items;
determining whether or not the selected items satisfy the predetermined criteria;
if the predetermined criteria is satisfied, configuring the apparatus in a second mode of operation in which access to the at least one function of the apparatus is enabled; wherein, if the predetermined criteria is not satisfied the apparatus is not configured in the second mode of operation.

34-40. (canceled)
